(19) United States
(12) Patent Application Publication
(10) Pub. No.: US 2015/0048920 A1
(43) Pub. Date: Feb. 19, 2015

(54) INDUCTOR ELEMENT AND METHOD OF MANUFACTURING THE SAME

(71) Applicant: SAMSUNG ELECTRO-MECHANICS CO., LTD., Suwon-si (KR)

(72) Inventors: Hwan Soo LEE, Suwon-si (KR); Hye Yeon CHA, Suwon-si (KR); Young Sik CHOI, Suwon-si (KR); Sung Kwon WI, Suwon-si (KR)

(21) Appl. No.: 14/459,963

(22) Filed: Aug. 14, 2014

(30) Foreign Application Priority Data
Aug. 14, 2013 (KR) 10-2013-0096645

(51) Int. Cl. H01F 27/24; C25D 7/00; H01F 41/02; C25D 5/02

(52) U.S. Cl. CPC H01F 27/24; C25D 5/02; C25D 7/00; H01F 41/02
USPC 336/219; 205/122

(57) ABSTRACT

Disclosed herein is an inductor element having an internal electrode in which a first plating layer and a second plating layer having a coil shape are embedded, the inductor element including: a first plating layer formed on a support member; an insulating layer covering the first plating layer and provided with an opening which exposes an upper surface of the first plating layer; and a second plating layer filled in the opening, whereby the inductor element in which the internal electrode having a high aspect ratio is embedded is implemented.

This application claims the foreign priority benefit under 35 U.S.C. Section 119 of Korean Patent Application Serial No. 10-2013-0096645 entitled “Inductor Element And Method Of Manufacturing The Same” filed on Aug. 14, 2013, which is hereby incorporated by reference in its entirety into this application.

### BACKGROUND OF THE INVENTION

1. Technical Field

The present invention relates to an inductor element, and more particularly, to a structure of an internal electrode embedded in an inductor element.

2. Description of the Related Art

An inductor element is one of the important passive devices configuring an electronic circuit, along with a resistor and a capacitor, and has been mainly used in a power supply circuit, such as a DC-DC converter, within an electronic device or has been widely used as a component for removing noise or configuring an LC resonance circuit. Among them, recently, as the multi driving for communications, cameras, games, and the like, in a smart phone, a tablet PC, and the like is required, the use of a power inductor with the reduced loss of current and the increased efficiency has been increased.

The inductor element may generally be provided by forming external terminals at both ends of a ceramic element in which an internal electrode having a coil shape is embedded. An external terminal is bonded to an end of the internal electrode exposed outside of the ceramic element and thus the external is electrically conducted to the internal electrode, such that the internal electrode is applied with external power (current) through the external terminal to form a magnetic path.

Meanwhile, with the development of IT technologies, miniaturization and thinness of electronic devices are accelerated, such that a PCB may be thinned and various devices mounted thereon may be miniaturized. With the tendency, a size of various inductor elements in addition to a power inductor has been also thinned and in order to implement inductance above a predetermined level and increase efficiency of current consumption, improvement in a direct current resistance (Rdc) characteristic and a Q characteristic has been urgently required.

Therefore, a patent in which in terms of a material, a ferrite material having a higher saturation magnetization value is used or in terms of a method, the area of the internal electrode is increased by a printing method for increasing a ratio of a width and a thickness of the internal electrode, that is, an aspect ratio or a structural method for forming a high aspect ratio to reduce an insertion loss of the inductor has proposed.

Referring to Patent Document (Korean Patent Laid-Open Publication No. 10-2003-0020603), in order to increase the aspect ratio of the internal electrode, the internal electrode is formed to satisfy a predetermined aspect ratio by applying a photosensitive layer having a predetermined thickness on one surface of a substrate, forming an opening having a coil pattern on the photosensitive layer, and plating and filling the inside of the opening.

That is, the above Patent Document discloses a photolithography process for forming the opening having the coil pattern on the photosensitive layer, as one of the processes for forming the internal electrode satisfying a predetermined aspect ratio using a thick photosensitive layer. In this case, however, in order to harden a lower portion of the photosensitive layer, exposure and developing conditions need to be strengthened. In this case, due to a thick thickness, an upper portion of the photosensitive layer is excessively hardened and the lower portion thereof is relatively less hardened, and thus an undercut may occur, such that a form of the internal electrode may be uniformly formed.

Further, during a process of removing a seed layer of the lower portion of the internal electrode, an etching solution does not smoothly flow between patterns of the internal electrode due to a narrow pattern interval and a high thickness of the internal electrode and thus the seed layer is not etched, such that the patterns of the internal electrode may be short-circuited to each other.

### RELATED ART DOCUMENT

### Patent Document

(Patent Document 1) Patent Document: Korean Patent Laid-Open Publication No. 10-2003-0020603

### SUMMARY OF THE INVENTION

An object of the present invention is to provide an inductor element which satisfies a predetermined aspect ratio and has an internal electrode having a more structurally stabilized form embedded therein, and a method of manufacturing the same.

According to an exemplary embodiment of the present invention, there is provided an inductor element having an internal electrode in which a first plating layer and a second plating layer having a coil shape are embedded, the inductor element including: a first plating layer formed on a support member; an insulating layer covering the first plating layer and provided with an opening which exposes an upper surface of the first plating layer; and a second plating layer filled in the opening.

A thickness of the first plating layer may be larger than that of the second plating layer.

A width of the second plating layer may be equal to or smaller than that of the first plating layer.

A portion of the second plating layer may protrude outside of the opening.

The protruding portion of the second plating layer protruding outside of the opening may have a semi-spherical shape.

A protruding width of the second plating layer may be equal to or larger than that of the second plating layer.

The inductor element may further include: an insulating layer covering the second plating layer.

The inductor element may further include: an opening formed on the insulating layer covering the second plating layer and exposing an upper surface of the second plating layer; and a third plating layer filled in the opening.

According to another exemplary embodiment of the present invention, there is provided a method of manufacturing an inductor element, including: forming a first plating layer on a support member; forming an insulating layer covering the first plating layer; forming an opening exposing an upper surface of the first plating layer by selectively etching the insulating layer; and forming a second plating layer by filling and plating an inside of the opening.

The first plating layer may be formed by using any one of a subtractive method, an additive method, a semi-additive method, and a modified semi-additive method.

The second plating layer may be formed by performing electroplating using the first plating layer as a lead-in wire.

In the forming of the opening, a width of the opening may be formed to be equal to or smaller than that of the first plating layer.

In the forming of the second plating layer, a portion of the second plating layer may protrude outside of a via hole.

The method of manufacturing an inductor element may further include: forming an insulating layer covering the second plating layer, after the forming of the second plating layer.

The method of manufacturing an inductor element may further include: forming an opening exposing an upper surface of the second plating layer by selectively etching the insulating layer covering the second plating layer; and forming a third plating layer by filling and plating the inside of the opening formed on the insulating layer covering the second plating layer.

### BRIEF DESCRIPTION OF THE DRAWINGS

FIG. 1 is a cross-sectional view of an internal electrode embedded in an inductor element according to an exemplary embodiment of the present invention.

FIGS. 2A and 2B are diagrams illustrating another exemplary embodiment of the present invention.

FIGS. 3 to 7 are process diagrams sequentially illustrating a method of manufacturing an inductor element according to an exemplary embodiment of the present invention.

### DESCRIPTION OF THE PREFERRED EMBODIMENTS

Various advantages and features of the present invention and methods accomplishing thereof will become apparent from the following description of exemplary embodiments with reference to the accompanying drawings. However, the present invention may be modified in many different forms and it should not be limited to exemplary embodiments set forth herein. These exemplary embodiments may be provided so that this disclosure will be thorough and complete, and will fully convey the scope of the invention to those skilled in the art.

Terms used in the present specification are for explaining exemplary embodiments rather than limiting the present invention. Unless explicitly described to the contrary, a singular form includes a plural form in the present specification. Further, the word “constituents”, “steps”, “operations”, and/or “elements” mentioned herein will be understood to imply the inclusion of stated constituents, steps, operations and/or elements but not the exclusion of any other constituents, steps, operations and/or elements.

Hereinafter, a configuration and an action effect of the present invention will be described in more detail with reference to the accompanying drawings.

Hereinafter, a configuration and an acting effect of exemplary embodiments of the present invention will be described in more detail with reference to the accompanying drawings.

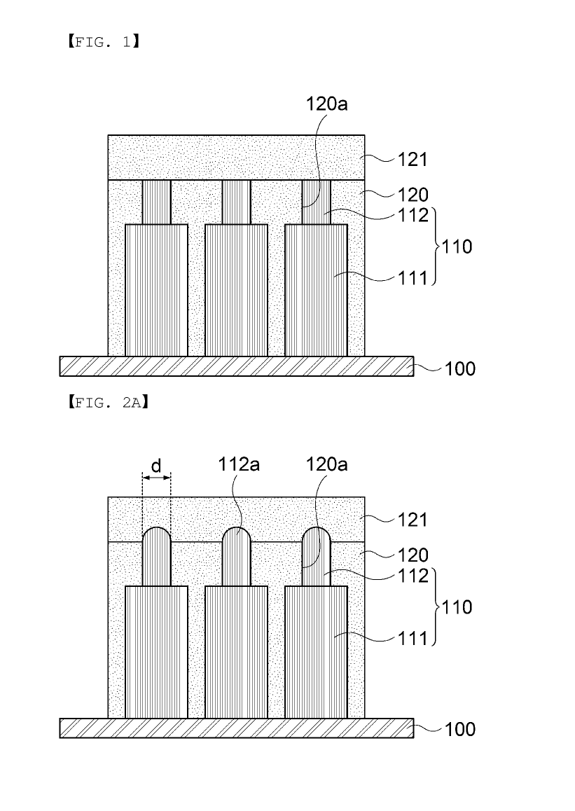

FIG. 1 is a cross-sectional view of an internal electrode embedded in an inductor element according to an exemplary embodiment of the present invention. Additionally, components shown in the accompanying drawings are not necessarily shown to scale. For example, sizes of some components shown in the accompanying drawings may be exaggerated as compared with other components in order to assist in the understanding of the exemplary embodiments of the present invention. Meanwhile, throughout the accompanying drawings, the same reference numerals will be used to describe the same components. For simplification and clearness of illustration, a general configuration scheme will be shown in the accompanying drawings, and a detailed description of the feature and the technology well known in the art will be omitted in order to prevent a discussion of exemplary embodiments of the present invention from being unnecessarily obscure.

The inductor element according to the exemplary embodiment of the present invention has a hexahedral shape of a ceramic element which is manufactured to have a predetermined chip size (for example, 2012 (2.0 mm×1.2 mm×1.2 mm), 1005 (1.0 mm×0.5 mm×0.5 mm), 0603 (0.6 mm×0.3 mm×0.3 mm), 0402 (0.4 mm×0.2 mm×0.2 mm), and the like). Referring to FIG. 1, an inside of the inductor element may be provided with internal electrodes 110 having a coil shape.

The internal electrode 110 is formed on a support member 100 of an insulating thin film and may be provided with insulating layers 120 and 121 formed to enclose a surface of the internal electrode 110 to protect the internal electrode from the outside and impart insulating property. Further, an inside of a chip is filled with a ceramic material, for example, a ceramic material composed of Fe—Ni—Zn oxides, Fe—Ni—Zn—Cu oxides, metallic ferrites such as Fe, Ni, and Fe—Ni (permalloy), and the like, to smooth a flow of magnetic flux.

In order to clearly show only the features of the exemplary embodiment of the present invention, the case in which the internal electrode 110 is formed only on one surface of the support member 100 is illustrated in drawings. However, unlike this, the internal electrodes 110 may be formed on both surfaces of the support member 100 to face each other. In this case, the internal electrodes 110 on both surfaces thereof may be electrically connected to each other through a via penetrating through any one portion of the support member 100.

In more detail, the internal electrode 110 may have a configuration of a first plating layer 111 having a coil shape and a second plating layer 112 formed thereon, and may be provided with an insulating layer 120 covering the first plating layer 111 and an insulating layer 121 covering the second plating layer 112. That is, according to the exemplary embodiment of the present invention, the internal electrode 110 satisfying a predetermined aspect ratio (a ratio of thickness to line width of a pattern) may be formed by sequentially forming the first plating layer 111 and the second plating layer 112.

The first plating layer 111 may be formed on the support member 100 by a subtractive method, an additive method, a semi-additive method, a modified semi-additive method, and the like and as a construction material thereof, at least any one metal selected from a group consisting of Ni, Al, Fe, Cu, Ti, Cr, Au, Ag, and Pd having excellent electrical conductivity may be used.

Further, the second plating layer 112 may be formed by filling at least any one metal selected from a group consisting of Ni, Al, Fe, Cu, Ti, Cr, Au, Ag, and Pd on an opening 120a formed on the insulating layer 120 which covers the first plating layer 111.

As such, since the first plating layer 111 supports the second plating layer 112 and in terms of a process, may be more easily formed than the second plating layer 112, a thickness of the first plating layer 111 may be formed to be larger than that of the second plating layer 112. However, when the thickness is formed to be much larger than the line width, the internal electrode is structurally instable and thus the pattern thereof may collapse, whereas when the thickness is formed to be much smaller than the line width, the required aspect ratio may not be satisfied and thus the thickness of the first plating layer 111 needs to be appropriately set in consideration of this.

Meanwhile, as the chip is miniaturized, an interval between the patterns of the internal electrode 110 is considerably narrow. In order to accurately match between the first plating layer 111 and the second plating layer 112, a width of the second plating layer 112 may be formed to be smaller than that of the first plating layer 111. As such, when the width of the second plating layer 112 is formed to be small, the interval between the patterns of the second plating layer 112 is widened, such that the matching with the first plating layer 111 may be facilitated, but when the width of the second plating layer 112 is formed to be too small, the area is reduced so much, which may be contradictory to an object of the present invention to increase the aspect ratio so as to increase the area of the internal electrode. Therefore, the width of the second plating layer 112 needs to be set to be appropriate value in consideration of this.

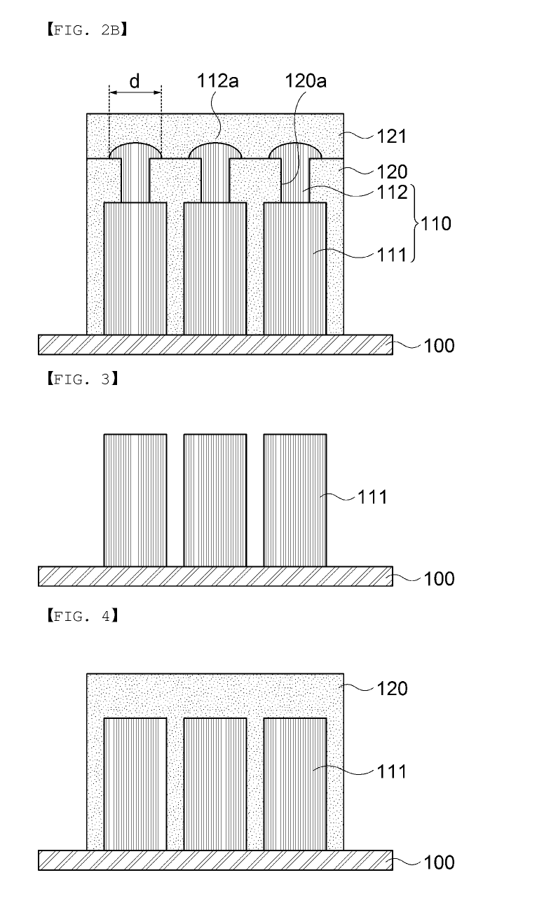

FIGS. 2A and 2B are diagrams another exemplary embodiment of the present invention. Referring to FIGS. 2A and 2B, a portion of the second plating layer 112 may protrude outside of the opening 120a. This may be naturally formed by filling a larger amount of metal than a volume of the opening 120a at the time of forming the second plating layer 112, such that a protruding portion 112a of the second plating layer 112 may have a semi-spherical shape as illustrated in FIGS. 2A and 2B.

Here, a protruding width d of the second plating layer 112 may be formed to be equal to a width of the opening 120a as illustrated in FIG. 2A or may be formed to be larger than a width of the opening 120a as illustrated in FIG. 2B. In terms of widening the area of the internal electrode 110, the latter form is more preferable, but as the protruding width d is formed to be larger, a short-circuit between the patterns may occur, such that protruding width d of the second plating layer 112 may be appropriately set in consideration of this.

As described above, according to the exemplary embodiment of the present invention, in addition to the first plating layer 111, the second plating layer 112 is additionally formed thereon. In addition, a part of the second plating layer 112 protrudes outside of the opening 120a, thereby maximizing the area of the internal electrode 110. As a result, the inductor element to largely reduce an insertion loss by remarkably reducing resistance of the internal electrode 110 may be provided.

Meanwhile, the internal electrode 110 configured of the first plating layer 111 and the second plating layer 112 is described as an example, but the internal electrode 110 may be configured of the plating layer of three layers or more. For example, when the internal electrode 110 is configured of the plating layer of three layers, the internal electrode 110 may further include an opening which is formed on the insulating layer 121 covering the second plating layer 112 to expose an upper surface of the second plating layer 112 and a third plating layer filled therein.

Hereinafter, a method of manufacturing the internal electrode 110 embedded in the inductor element according to the exemplary embodiment of the present invention will be described.

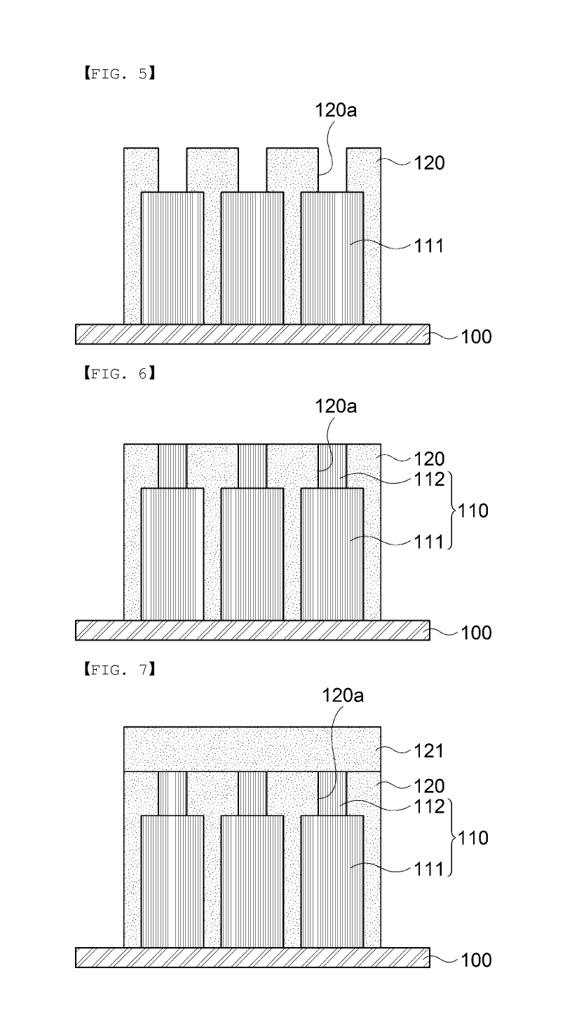

FIGS. 3 to 7 are process diagrams sequentially illustrating a method of manufacturing an inductor element according to an exemplary embodiment of the present invention. First, as illustrated in FIG. 3, a process of forming the first plating layer 111 on the prepared support member 110 is performed.

The first plating layer 111 may be formed using known circuit molding methods, such as a subtractive method, an additive method, a semi-additive method, and a modified semi-additive method. The thickness of the first plating layer needs to be appropriately set in consideration of the required aspect ratio and the stability of the structure as described above.

When the first plating layer 111 is completed, as illustrated in FIG. 4, a process of forming the insulating layer 120 covering the first plating layer 111 is performed.

A material of the insulating layer 120 may be appropriately selected in consideration of insulating property, heat resistance, moisture resistance, and the like. For example, an example of an optimal polymer material for forming the insulating layer 120 may include a thermosetting resin such as epoxy resin, a thermoplastic resin such as polyimide, or a resin formed by impregnating reinforcing materials, such as glass fiber and inorganic filler, therein, for example, a prepreg.

The insulating layer 120 may be formed by using various coating methods, such as a tape casting method, a spin coating method, and other inkjet printing method, and the thickness thereof is formed to be equal to that of the finally completed internal electrode 110.

When the insulating layer 120 is completed as described above, as illustrated in FIG. 5, a process of forming the opening 120a which selectively etches the insulating layer 120 to expose the upper surface of the first plating layer 111 is performed.

The opening 120a may be formed by attaching a mask (not illustrated) having the pattern corresponding to the opening 120a on the insulating layer 120 and then performing an exposure and developing process. In this case, the opening 120a is formed by controlling a pattern width of the mask so that the width of the second plating layer 112 formed by the subsequent process is equal to or smaller than that of the first plating layer 111.

When the opening 120a is completed as described above, as illustrated in FIG. 6, a process of forming the second plating layer 112 by filling and plating the inside of the opening 120a is performed, such that the internal electrode 110 embedded in the inductor element according to the exemplary embodiment of the present invention may be finally completed.

The second plating layer 112 may be formed by filling at least any one metal selected from a group consisting of Ni, Al, Fe, Cu, Ti, Cr, Au, Ag, and Pd in the opening 120a by performing electroplating using the first plating layer 111 as a lead-in wire. In this case, as illustrated in FIGS. 2A and 2B, the second plating layer 112 having a shape protruding outside of the opening 120a may also be formed by filling a larger amount of metal than the volume of the opening 120a.

In order to protect the second plating layer 112 from the outside, as illustrated in FIG. 7, a process of forming the insulating layer 121 covering the second plating layer 112 is further performed. Meanwhile, when the internal electrode 110 is formed in the plating layer of 3 layers, the third plating layer may be formed by forming the opening which exposes the upper surface of the second plating layer 112 by selectively etching the insulating layer 121 and then filling metal therein by the same method as the method of forming the second plating layer 112.

With the inductor element according to the exemplary embodiments of the present invention, the inductor element satisfying the predetermined aspect ratio may be provided without causing the short-circuit between the internal electrodes by sequentially forming the plating layers configuring the internal electrodes, thereby remarkably reducing the resistance of the internal electrodes and greatly reducing the insertion loss of the inductor.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. An inductor element having an internal electrode in which a first plating layer and a second plating layer having a coil shape are embedded, the inductor element comprising:
a first plating layer formed on a support member;
an insulating layer covering the first plating layer and provided with an opening which exposes an upper surface of the first plating layer; and
a second plating layer filled in the opening.

2. The inductor element according to claim 1, wherein a thickness of the first plating layer is larger than that of the second plating layer.

3. The inductor element according to claim 1, wherein a width of the second plating layer is equal to or smaller than that of the first plating layer.

4. The inductor element according to claim 1, wherein a portion of the second plating layer protrudes outside of the opening.

5. The inductor element according to claim 4, wherein the protruding portion of the second plating layer protruding outside of the opening has a semi-spherical shape.

6. The inductor element according to claim 4, wherein a protruding width of the second plating layer is equal to or larger than that of the second plating layer.

7. The inductor element according to claim 1, further comprising:
an insulating layer covering the second plating layer.

8. The inductor element according to claim 7, further comprising:
an opening formed on the insulating layer covering the second plating layer and exposing an upper surface of the second plating layer; and a third plating layer filled in the opening.

9. A method of manufacturing an inductor element, comprising:
forming a first plating layer on a support member;
forming an insulating layer covering the first plating layer;
forming an opening exposing an upper surface of the first plating layer by selectively etching the insulating layer; and
forming a second plating layer by filling and plating an inside of the opening.

10. The method according to claim 9, wherein the first plating layer is formed by using any one of a subtractive method, an additive method, a semi-additive method, and a modified semi-additive method.

11. The method according to claim 9, wherein the second plating layer is formed by performing electroplating using the first plating layer as a lead-in wire.

12. The method according to claim 9, wherein in the forming of the opening, a width of the opening is formed to be equal to or smaller than that of the first plating layer.

13. The method according to claim 9, wherein in the forming of the second plating layer, a portion of the second plating layer protrudes outside of a via hole.

14. The method according to claim 9, further comprising:
forming an insulating layer covering the second plating layer, after the forming of the second plating layer.

15. The method according to claim 14, further comprising:
forming an opening exposing an upper surface of the second plating layer by selectively etching the insulating layer covering the second plating layer; and
forming a third plating layer by filling and plating the inside of the opening formed on the insulating layer covering the second plating layer.
